(19) United States
(12) Patent Application Publication
(10) Pub. No.: US 2014/0293580 A1
(43) Pub. Date: Oct. 2, 2014

(54) PROTECTOR DEVICE WITH MICRO STRUCTURE PATTERN

(71) Applicant: Cheng Kuo Kuan, New Taipei City (TW)

(72) Inventor: Cheng Kuo Kuan, New Taipei City (TW)

(21) Appl. No.: 14/016,336

(22) Filed: Sep. 3, 2013

(30) Foreign Application Priority Data
Mar. 26, 2013 (TW) 102110706

(51) Int. Cl. F21V 7/00

(52) U.S. Cl. CPC F21V 7/00
USPC 362/97.1

(57) ABSTRACT

A protector device includes a main body; a back adhesive layer disposed on a lower side of the main body for adhesively mounted on a mobile device; an anti-scratch layer disposed on an upper side of the main body; and one micro structure pattern layer disposed between the anti-scratch layer and the upper side of the main body or between the back adhesive layer and the lower side of the main body, wherein, when the backlight reflection of the mobile device is lower than the environmental light, micro structure on the micro structure pattern layer reflects and displays a reflected pattern over a display region of the mobile device and when the backlight reflection of the mobile device is greater than the environmental light, the micro structure pattern layer turns to be transparent so that operation and viewing of the mobile device is not obstructed.

### CROSS-REFERENCE TO RELATED APPLICATION

This application claims the priority of Taiwanese patent application No. 102110706, filed on Mar. 26, 2013, which is incorporated herewith by reference.

### BACKGROUND OF THE INVENTION

1. Field of the Invention

The present invention relates generally to a protector device, and more particularly to a protector device for a mobile device such that when the backlight reflection magnitude of the mobile device is lower than that of the environmental light, the protector device reflects and thus displays a reflected pattern over a display region of the mobile device and when the backlight reflection magnitude of the mobile device is greater than that of the environmental light, the protector device turns to be transparent so that operation and viewing of the mobile device is not obstructed.

2. The Prior Arts

With the rapid advance in the flat panel industry, the 3C consumer appliances available in the market generally utilize a flat plate screen for displaying an image. In the touch screen operation, since a glass plate is disposed on the upper surface of the flat plate screen, the consumers generally buy a relatively cheap protector device with anti-scratch ability to cover the glass plate in order to protect the device from being scratched. In recent years, Apple Inc. has introduced iPhone, iPad such that the specifications of the 3C consumer appliances are in the trend different from a few years ago. Under the present condition, the consumers utilizing the similar electronic product is generally noticed so that the urgent problem to solve is how to recognize or identify an individual electronic product from the others via an external appearance.

Presently, there are lots of peripheral devices available in the markets and protector devices are a must to protect the devices from being collided or scratched. However, a majority of the protector devices are transparent and hence once the protector device is mounted over a mobile device, the consumer cannot differentiate which one is his or hers. It is highly desirable to develop a protector device with specific characteristics so that the consumer can recognize his or her mobile device at one sight upon identifying the protector device.

### SUMMARY OF THE INVENTION

A primary objective of the present invention is to provide a protector device, more particularly to a protector device with micro structure pattern for a mobile device so that the former can be mounted over the latter. The protector device accordingly includes a main body, a back adhesive layer, an anti-scratch layer and at least one micro structure pattern layer. The back adhesive layer is disposed on a lower side of the main body for adhesively mounted on an external surface of the mobile device. The anti-scratch layer is disposed on an upper side of the main body. The micro structure pattern layer is disposed between the anti-scratch layer and the upper side of the main body or between the back adhesive layer and the lower side of the main body, wherein, when the backlight reflection magnitude of the mobile device is lower than that of the environmental light, micro structure on the micro structure pattern layer reflects and thus displays a reflected pattern over a display region of the mobile device and when the backlight reflection magnitude of the mobile device is greater than that of the environmental light, the micro structure pattern layer turns to be transparent so that operation and viewing of the mobile device is not obstructed.

The protector device of the present invention includes the micro structure pattern layer and when the same is mounted on the mobile device, the mobile device is prevented from being scratched in addition to providing specific reflected pattern when the backlight reflection magnitude of the mobile device is lower than that of the environmental light, thereby providing aesthetic beauty thereof.

### BRIEF DESCRIPTION OF THE DRAWINGS

Other features and advantages of the present invention will become more apparent in the following detailed description of the preferred embodiment of this invention with reference to the accompanying drawings, in which:

FIG. 1 is a perspective view of a protector device of the present invention;

FIG. 2A is a cross-sectional side view of a first preferred embodiment of the protector device of the present invention;

FIG. 2B is a cross-sectional view of a second preferred embodiment of the protector device of the present invention;

FIG. 2C is a cross-sectional view of a third preferred embodiment of the protector device of the present invention;

FIGS. 3A and 3B respectively illustrate situations where the protector device of the present invention is mounted on a mobile device when the backlight reflection magnitude of the mobile device is lower and/or greater than that of the environmental light; and

FIGS. 4A and 4B respectively illustrate situations where the protector device of the present invention is mounted on a mobile device and is viewed from different angles when the backlight reflection magnitude of the mobile device is lower and/or greater than that of the environmental light.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

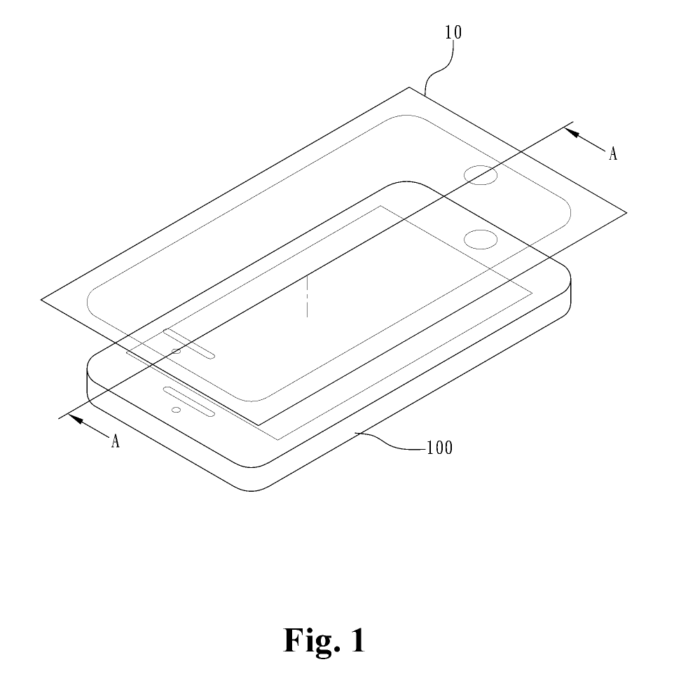

FIG. 1 is a perspective view of a protector device of the present invention. As illustrated, the protector device 10 of the present invention is mounted on a mobile device 100 in order to protect the same from being scratched. The mobile device 10 includes a cellular mobile phone, a tablet computer, a notebook computer, an MP3, a digital camera and etc.

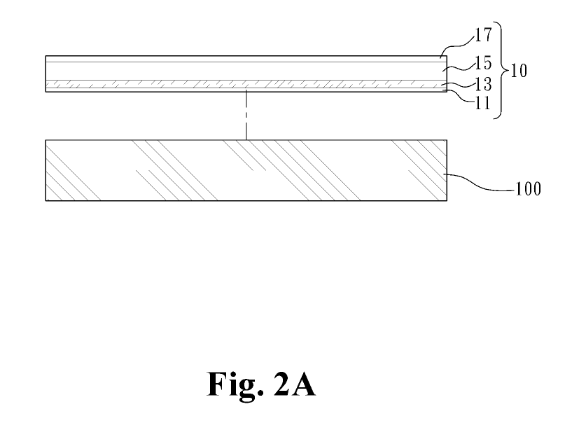

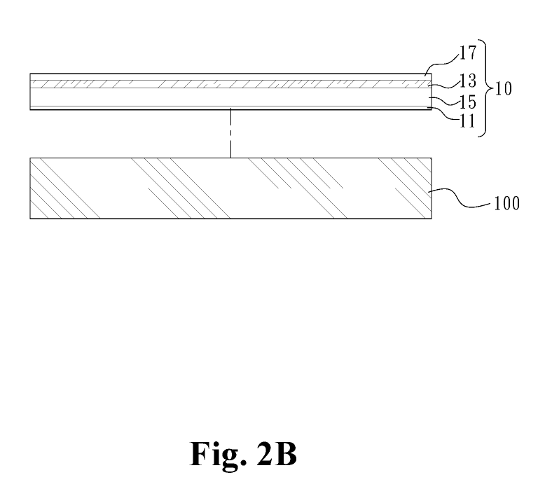

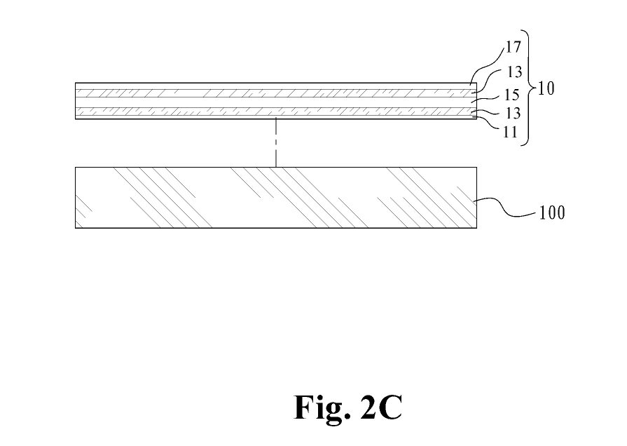

FIG. 2A is a cross-sectional side view of the first preferred embodiment of the protector device of the present invention. The protector device 10 for a mobile device according to the present invention includes a main body 15, a back adhesive layer 11, at least one micro structure pattern layer 13 and an anti-scratch layer 17. In the present preferred embodiment, the back adhesive layer 11 is disposed on a lower side of the main body 15 for adhesively mounted on an external surface of the mobile device 100. The anti-scratch layer 17 is disposed on an upper side of the main body 15, wherein the main body 15 is made from either polyethylene terephthalate (PET) or polycarbonate (PC).

FIG. 2B is a cross-sectional view of the second preferred embodiment of the protector device of the present invention. The second preferred embodiment is similar to the first preferred embodiment in structure, except that in the second preferred embodiment, the micro structure pattern layer 13 is disposed between the anti-scratch layer 17 and the upper side of the main body 15. FIG. 2C is a cross-sectional view of the third preferred embodiment of the protector device of the present invention. The third preferred embodiment is similar to the first preferred embodiment in structure, except that in the third preferred embodiment, two micro structure pattern layers 13 are employed, wherein, one is disposed between the anti-scratch layer 17 and the upper side of the main body 15 and the other one is disposed between the back adhesive layer 11 and the lower side of the main body 15.

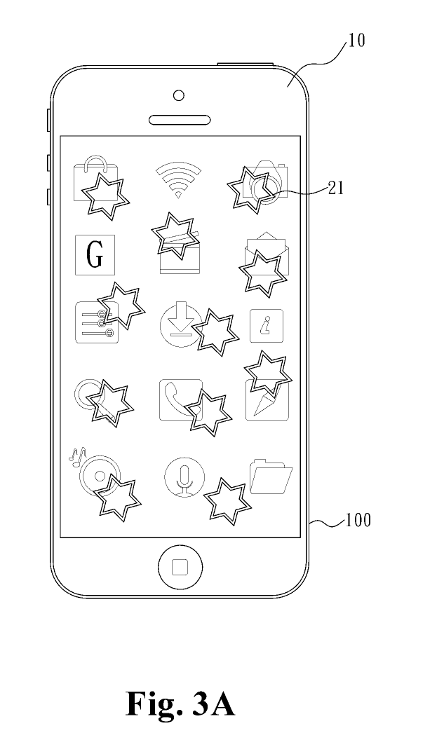

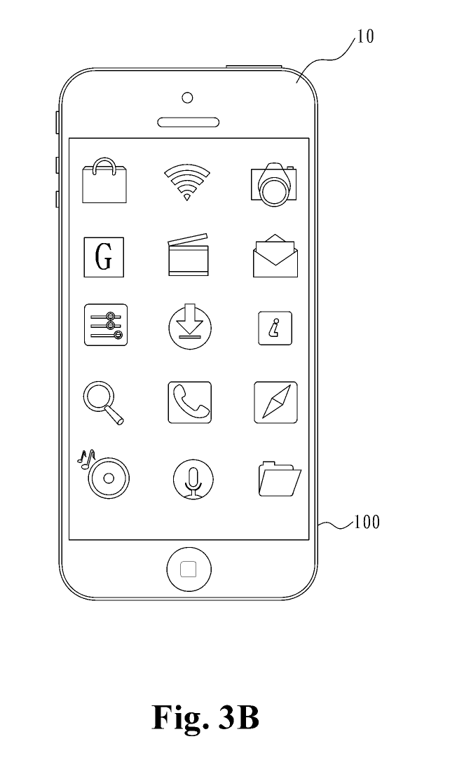

FIGS. 3A and 3B respectively illustrate situations where the protector device of the present invention is mounted on a mobile device when the backlight reflection magnitude of the mobile device is lower and/or greater than that of the environmental light. As best shown in FIG. 3A, when the backlight reflection magnitude of the mobile device 100 is lower than that of the environmental light, the micro structure on the micro structure pattern layer 13 reflects and thus displays a reflected pattern 21 over a display region of the mobile device 100. As best illustrated in FIG. 3B, when the backlight reflection magnitude of the mobile device 100 is greater than that of the environmental light, the micro structure pattern layer 13 of the protector device 10 turns to be transparent so that operation and viewing of the mobile device 100 is not obstructed.

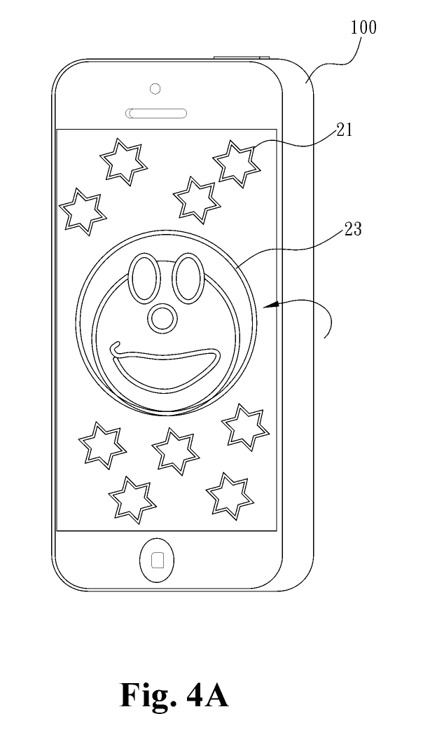

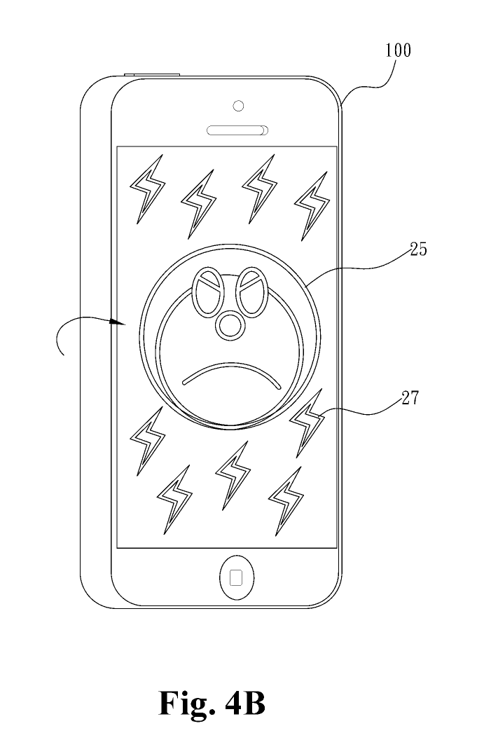

FIGS. 4A and 4B respectively illustrate situations where the protector device of the present invention is mounted on a mobile device 100 and is viewed from different angles when the backlight reflection magnitude of the mobile device is lower than that of the environmental light. As best illustrated in FIGS. 4A and 4B, when the backlight reflection magnitude of the mobile device 100 is lower than that of the environmental light and the mobile device 100 is viewed from a first angle, the micro structure on the micro structure pattern layer 13 reflects a first reflected pattern 22, a second reflected pattern 25 and a third reflected pattern 27, wherein the reflected patterns are different from one another in configuration. Alternatively, when the backlight reflection magnitude of the mobile device 100 is lower than that of the environmental light and the mobile device 100 is viewed from a second angle different from the first angle, the micro structure on the micro structure pattern layer 13 reflects a first color, a second color and a third color, wherein the reflected colors are different from one another. Note that the number of reflected pattern and colors should not be restricted.

The distinct feature of the present invention resides in that since the protector device of the present invention when mounted on a mobile device provides and thus reflects specific reflected pattern or colors when the backlight reflection magnitude of the mobile device 100 is lower than that of the environmental light, thereby providing an aesthetic and pleasing appearance in addition to being prevented from scratch. The aesthetic appearance enables quick recognizing of the mobile device.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A protector device for a mobile device, comprising:
a main body;
a back adhesive layer disposed on a lower side of said main body for mounting on an external surface of the mobile device;
an anti-scratch layer disposed on an upper side of said main body; and
at least one micro structure pattern layer disposed between said anti-scratch layer and said upper side of said main body or between said back adhesive layer and said lower side of said main body,
wherein when the backlight reflection magnitude of the mobile device is lower than that of the environmental light, micro structure on said micro structure pattern layer reflects and thus displays a reflected pattern over a display region of the mobile device and when the backlight reflection magnitude of the mobile device is greater than that of the environmental light, said micro structure pattern layer turns to be transparent so that operation and viewing of the mobile device is not obstructed.

2. The protector device according to claim 1, wherein said main body is made from either polyethylene terephthalate (PET) or polycarbonate (PC).

3. The protector device according to claim 1, wherein when the backlight reflection magnitude of the mobile device is lower than that of the environmental light, said micro structure patter layer reflects and thus displays different reflected patterns when viewed from different angles.

4. The protector device according to claim 1, wherein when the backlight reflection magnitude of the mobile device is lower than that of the environmental light, said micro structure patter layer reflects and thus displays different colors when viewed from different angles.
